(19) United States
(12) Patent Application Publication
(10) Pub. No.: US 2007/0230267 A1
(43) Pub. Date: Oct. 4, 2007

(54) Method for Mixing and Homogenisation of Binding Agents and Additives

(75) Inventor: Lars Schou, Esbjerg (DK)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Agro Biomass Consult ApS, Esbjerk V (DK)

(21) Appl. No.: 10/561,959

(22) PCT Filed: Jun. 24, 2003
(86) PCT No.: PCT/DK03/00432

§ 371 Date: Mar. 14, 2007

(51) Int. Cl. B01F 3/00

(52) U.S. Cl. 366/348

(57) ABSTRACT

There is described a method for mixing and homogenisation of binding agents and additives in particular formulated for use the production of panels made from organic fibres and comprising the following method steps: dosing water-soluble UF/MUF resin in the range of 90% by weight, dosing water-soluble hardener agent in the range of 5% by weight, dosing not water-soluble penetration agent in the range of 2-5% of weight, dosing not water-soluble foaming agent in the range of 2-5% of weight, continuous dosing these fluids into a collective tube leading to a common dynamic mixing and homogenisation unit, and operation said dynamic and homogenisation unit until a homogeneous and activated resin mixture is effected, so that said mixture having a structure like an emulsion containing wax penetration micro drops.

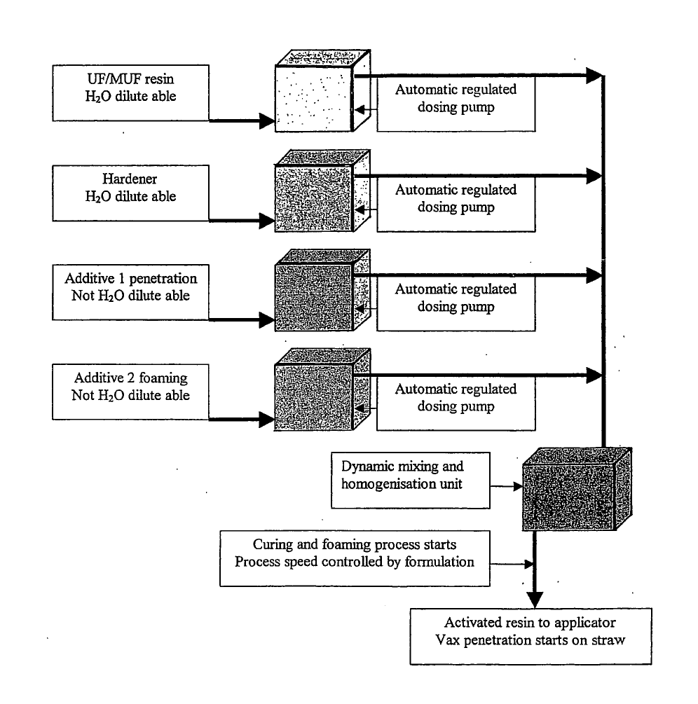

### FIELD OF THE INVENTION

The present invention relates to a method for mixing and homogenisation of binding agents and additives in particular formulated for use in the production of panels from organic fibres.

### BACKGROUND OF THE INVENTION

Known cores for doors, partitions, furniture and the like consist mostly of cardboard, chip board or wood, as it is common to use cores made from cardboard, if it concerns very easy and cheap constructions, for instance door plates; while the normal alternative, if more strength is needed, is chip board, which in return involve a more expensive and more heavy construction, for instance of plates for doors and furniture.

A known method for production of cores of the above-mentioned type makes it possible to produce improved cores, which are easy to optimize for the actual use, and which are easy to integrate in relation to the form in the finished item, for instance profiled plates for doors or furniture, where biomass is used as filling material, for instance in form of straw and stalks, and where a binding agent is used, mainly consisting of either UF-glue (urea-formaldehyd) or MUF-glue (melamin urea-formaldehyd), together with a foaming agent.

This known method may be such modified that the core is form-pressed between pre-fabricated shells with desired shape corresponding to the profiling of the finished door plate or furniture plate. For special situations pre-fabricated shells having asymmetric profiling may be used—for instance in such a manner that door plate or furniture plate are having a plane inner side and a profiled outer side.

Furthermore it is known to produce a core in accordance with this known method and provided as a form-pressed mainly plate-shaped item, where the filling material consists of biomass, for instance in form of disintegrated straw and stalks, and where the binding agent mainly consists of UF-glue or MUF-glue, to which a foaming agent is added.

This known core is provided as a form-pressed plate, which after the hardening is milled in shape for use in profiled doors and furniture plates. Or this known core may furthermore be provided as a laminate as the core is form-pressed between pre-fabricated shells with shape corresponding to the desired profiling of the finished door plate or furniture plate. Alternatively this known core may be such provided, that the filling material is partly disintegrated, preferably in bundles of fibre so that the core has a uniform pore structure (dentity profile).

### BRIEF DESCRIPTION OF THE INVENTION

According to the invention the method for mixing and homogenisation of binding agents and additives in particular formulated for use the production of panels made from organic fibres and comprises the following method steps:
dosing water-soluble UF/MUF resin in the range of 90% by weight,
dosing water-soluble hardener agent in the range of 5% by weight,
dosing not water-soluble penetration agent in the range of 2-5% of weight,
dosing not water-soluble foaming agent in the range of 2-5% of weight,
continuous dosing these fluids into a collective tube leading to a common dynamic mixing and homogenisation unit, and
operation said dynamic and homogenisation unit until a homogeneous and activated resin mixture is effected, so that said mixture having a structure like an emulsion containing wax penetration micro drops.

By applying this homogeneous and activated (processed) resin mixture to organic fibres for instance in the form of disintegrated straw and stalks it is possible due to the micro sphere structure of the processed resin mixture to produce lighter particle boards compared to conventional technology, because the use of the processed resin mixture result a better distribution of the binder and a better wax penetration on disintegrated straw and stalks due to the forming of micro spheres between the fibres.

In order to obtain the best possible homogeneous and best mutual distribution of the different fluid components by the method according to the invention use is made of automatic regulated dosing pumps for the said dosing of each of said fluids extending in a common collective tube leading to said common dynamic mixer.

By the method according to the invention use is made of ammonium sulphate or ammonium chloride as hardener agent.

By the method according to the invention use is made of diphenylmethandiisocyanate as a penetration agent and polyols as a foaming agent.

### BRIEF DESCRIPTION OF THE DRAWING

The accompanying drawing shows a diagram illustrating the mixing and homogenisation process for the preparation of UF/MUF resins especially formulated for panel production based on organic fibres.

### DETAILED DESCRIPTION OF THE INVENTION

In the following the method according to the invention is described in more detail in connection with the following examples:

### EXAMPLE 1

By continuous dosing use is made of automatic regulated dosing pumps for the said dosing of each of the following fluids into a collective tube leading to a common dynamic mixing and homogenisation unit: Water-soluble UF/MUF resin in the range of 90% by weight, water-soluble hardener agent in the range of 5% by weight, not water-soluble penetration agent in the range of 2-5% of weight and not water-soluble foaming agent in the range of 2-5% of weight, consequence operation said dynamic and homogenisation unit until a homogeneous and activated resin mixture is effected, so that said mixture having a structure like an emulsion containing wax penetration micro drops.

### EXAMPLE 2

By continuous dosing use is made of automatic regulated dosing pumps for the said dosing of each of the following fluids into a collective tube leading to a common dynamic mixing and homogenisation unit: Water-soluble UF/MUF resin in the range of 90% by weight, water-soluble hardener agent in the form of ammonium sulphate or ammonium chloride in the range of 5% by weight, not water-soluble penetration agent in the form of diphenylmethandiisocynanate in the range of 2-5% of weight, and not water-soluble foaming agent in the form of polyols in the range of 2-5% of weight, consequence operation said dynamic and homogenisation unit until a homogeneous and activated resin mixture is effected, so that said mixture having a structure like an emulsion containing wax penetration micro drops.

### EXAMPLE 3

By continuous dosing use is made of automatic regulated dosing pumps for the said dosing of each of the following fluids into a collective tube leading to a common dynamic mixing and homogenisation unit: Water-soluble UF/MUF resin in the range of 90% by weight, water-soluble hardener agent in the range of 5% by weight, not water-soluble combined penetration and foaming agent in the range of 3-6% of weight, consequence operation said dynamic and homogenisation unit until a homogeneous and activated resin mixture is effected, so that said mixture having a structure like an emulsion containing wax penetration micro drops.

In other words the described mixing and homogenisation process for UF/MUF resins especially formulated for panel production based on organic fibres is a combination of chemical reactions of a fluid mix and strong mechanical action of the same. The result is a reacted homogeneous resin mix consisting of normal non-mixable fluids.

The formulation controls the following parameters:
Reaction speed
Penetration of natural wax layer of straw or organic fibres
Foaming effect and foaming of micro spheres

1. A method for mixing and homogenisation of binding agents and additives in particular formulated for use the production of panels made from organic fibres and comprising the following method steps:
dosing water-soluble UF/MUF resin in the range of 90% by weight,
dosing water-soluble hardener agent in the range of 5% by weight,
dosing not water-soluble penetration agent in the range of 2-5% of weight,
dosing not water-soluble foaming agent in the range of 2-5% of weight,
continuous dosing these fluids into a collective tube leading to a common dynamic mixing and homogenisation unit, and
operation said dynamic and homogenisation unit until a homogeneous and activated resin mixture is effected, so that said mixture having a structure like an emulsion containing wax penetration micro drops.

2. A method according to claim 1, characterized in that use is made of automatic regulated dosing pumps for the said dosing of each of said fluids.

3. A method according to claim 1, characterized in that use is made of ammonium sulphate as hardener agent.

4. A method according to claim 1, characterized in that use is made of ammonium chloride as hardener agent.

5. A method according to claim 1, characterized in that use is made of poly-urethane iso-cyanate as a combined penetration and foaming agent.

6. A method according to claim 1, characterized in that use is made of polyols as foaming agent.

7. A method according to claim 1, characterized in that use is made of diphenylmethandiisocyanate as penetration agent.
